(19) United States
(12) Patent Application Publication
(10) Pub. No.: US 2016/0274434 A1
(43) Pub. Date: Sep. 22, 2016

(54) CONDUCTIVE ASSEMBLY FOR CHANGING COLOR OF LENS

(71) Applicant: TINTABLE SMART MATERIAL CO., LTD., Tainan City (TW)

(72) Inventors: FU-YU TSAI, TAINAN CITY (TW); YI-WEN CHUNG, TAINAN CITY (TW)

(21) Appl. No.: 14/659,907

(22) Filed: Mar. 17, 2015

(51) Int. Cl. G02F 1/155; G02C 7/10

(52) U.S. Cl. CPC G02F 1/155; G02C 7/101

(57) ABSTRACT

A conductive assembly for changing a color of a lens is revealed herein to comprise first and second conductive devices separately disposed at an upper front and lower rear end faces of an electrochromic lens, and an electrical connection device connected with the first and second conductive devices. The first conductive device has a first indium tin oxide (ITO) conductive part on a surface of the electrochromic lens and a conductive part on the first ITO conductive part for connection to the electrical connection device. The second conductive device has a second indium tin oxide (ITO) conductive part on a surface of the electrochromic lens, an inner conductive part on the second ITO conductive part, an insulating part on the inner conductive part and an outer conductive part on the insulating part for connection to the inner conductive part and the electrical connection device.

### BACKGROUND OF THE INVENTION

1. Fields of the Invention

The present invention relates to a conductive assembly for changing the color of a lens, which not only makes the transmittance and color of the electrochromic lens more uniform but also extends the service life of the electrochromic lens.

2. Descriptions of Related Art

As referring to FIG. 5, it shows that a decomposed schematic diagram of a traditional architecture. The general positive conductive device 51 and negative conductive device 52 are respectively disposed at an upper and lower end of an electrochromic lens 5, and the positive conductive device 51 and the negative conductive device 52 are disposed at a front and rear end face of the electrochromic lens 5. The positive conductive device 51 is provided with a positive electrode conductive layer of indium tin oxide (ITO) 511 on the surface of the electrochromic lens 5, and an outside of the positive electrode conductive layer of indium tin oxide 511 is disposed with a positive electrode conductive side 512. The negative conductive device 52 is provided with a negative electrode conductive layer of indium tin oxide (ITO) 521 on the surface of the electrochromic lens 5, and an outside of the negative electrode conductive layer of indium tin oxide 521 is disposed with a negative electrode conductive side 522. The lengths of the positive electrode conductive layer of indium tin oxide 511 of the positive conductive device 51 and the negative electrode conductive layer of indium tin oxide 521 of the negative conductive device 52 are equal to the length of the electrochromic lens 5, so that the positive electrode conductive layer of indium tin oxide 511 and the negative electrode conductive layer of indium tin oxide 521 can be fitted completely at an upper or lower end of the electrochromic lens 5, and the positive conductive device 51 and the negative conductive device 52 are connected to an electrical connection device 53.

As referring to FIG. 6, it shows that a diagram of the traditional architecture in use. When the positive conductive device 51 and the negative conductive device 52 are inputted a forward power from the electrical connection device 53, and the power is transmitted from the positive electrode conductive side 512 of the positive conductive device 51 and the negative electrode conductive side 522 of the negative conductive device 52 to the electrochromic lens 5 through the positive electrode conductive layer of indium tin oxide 511 and the negative electrode conductive layer of indium tin oxide 521, so that the transmittance of the electrochromic lens 5 is lower, and the color is darker. However, when the positive conductive device 51 and the negative conductive device 52 are inputted a reverse power from the electrical connection device 53, and the power is transmitted from the positive electrode conductive side 512 and the negative electrode conductive side 522 to the electrochromic lens 5 through the positive electrode conductive layer of indium tin oxide 511 and the negative electrode conductive layer of indium tin oxide 521, so that the transmittance of the electrochromic lens 5 is higher, and the color is lighter.

Although the transmittance modification of the electrochromic lens 5 can achieve the desired efficacy through inputting forward or reverse power, a drawback is discovered during the procedure of the actual operation. In the process of changing the transmittance of the electrochromic lens 5, because of the power is transmitted from the electrical connection device 53 at the side of the electrochromic lens 5 to the positive conductive device 51 and the negative conductive device 52, then the power is transmitted from the positive electrode conductive side 512 of the positive conductive device 51 and the negative electrode conductive side 522 of the negative conductive device 52 to the electrochromic lens 5 through the positive electrode conductive layer of indium tin oxide 511 and the negative electrode conductive layer of indium tin oxide 521. Because of the power is transmitted from the electrical connection device 53 to the electrochromic lens 5 through the positive conductive device 51 and the negative conductive device 52, so the color of the end of the electrochromic lens 5 close to the electrical connection device 53 starts to change, and the transmittance changes from one side to another side of the lectrochromic lens 5 as the direction of the power transmission. Use for long period can cause the ageing of the side of the electrochromic lens 5 close to the electrical connection device 53 is higher that another side, so that the transmittance of two sides of the electrochromic lens 5 are not uniform.

### SUMMARY OF THE INVENTION

Therefore, a conductive assembly for changing the color of a lens is developed herein. The transmittance and color will be changed diagonally toward the center during the procedure of change of the transmittance and color of the electrochromic lens. Thus not only can the transmittance and color of the electrochromic lens more become uniform but also the service life of the electrochromic lens can be extended.

In order to achieve the above objectives, the technological means of a conductive assembly for changing the color of a lens in the present invention is revealed herein. It comprises a first conductive device and a second conductive device separately disposed at an upper front end face and a lower rear end face of an electrochromic lens, and an electrical connection device connected with the first and second conductive devices.

Further, the first conductive device is provided with a first indium tin oxide (ITO) conductive part on a first surface of the electrochromic lens, and a conductive part on the first ITO conductive part for connection to the electrical connection device. The second conductive device is provided with a second indium tin oxide (ITO) conductive part on a second surface of the electrochromic lens, an inner conductive part on the second ITO conductive part, an insulating part on the inner conductive part and an outer conductive part on the insulating part, wherein the insulating part is shorter than the inner and outer conductive parts, and the outer conductive part is connected to the electrical connection device at an end thereof and to the inner conductive part at the other end thereof.

### BRIEF DESCRIPTION OF THE DRAWINGS

The structure and the technical means adopted by the present invention to achieve the above and other objects can be best understood by refereeing to the following detailed description of the preferred embodiments and the accompanying drawings, wherein

FIG. 1 is a decomposed schematic diagram showing the conductive assembly for changing the color of a lens according to the present invention;

FIG. 2 is a schematic cross-sectional top view showing the conductive assembly for changing the color of a lens according to the present invention;

FIG. 3 is a partial enlarged schematic cross-sectional top view showing the conductive assembly for changing the color of a lens according to the present invention;

FIG. 4 is a diagram of the conductive assembly for changing the color of a lens in use according to the present invention;

FIG. 5 is a decomposed schematic diagram of a traditional architecture.

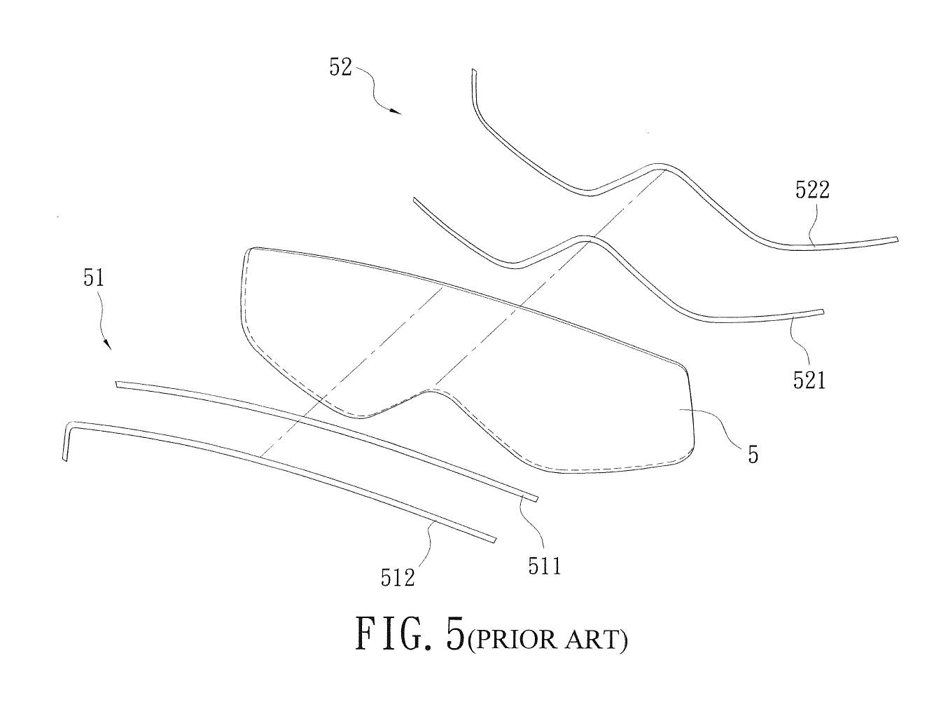

FIG. 6 is a diagram of the traditional architecture in use.

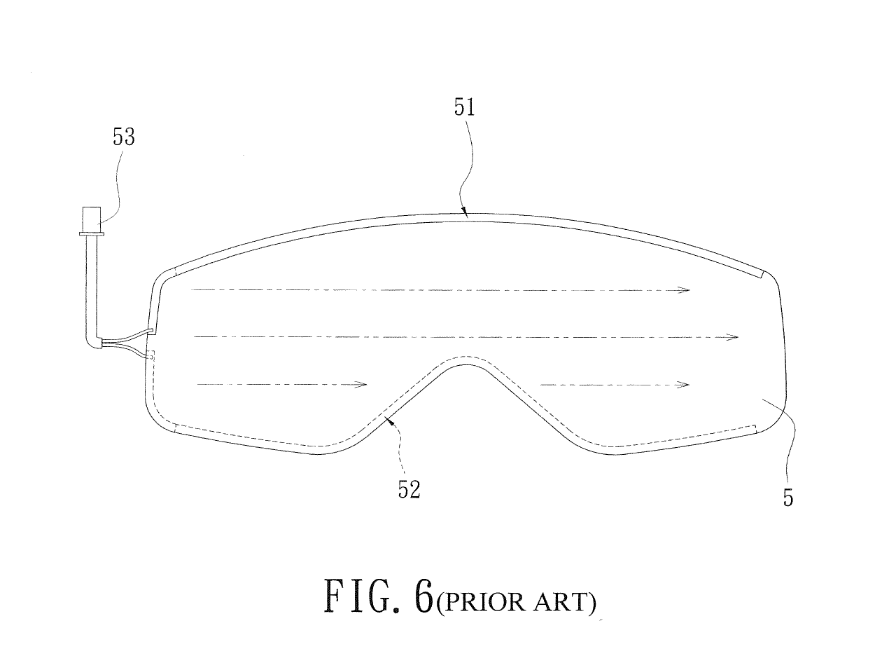

### DETAILED DESCRIPTION OF THE PREFERRED EMBODIMENT

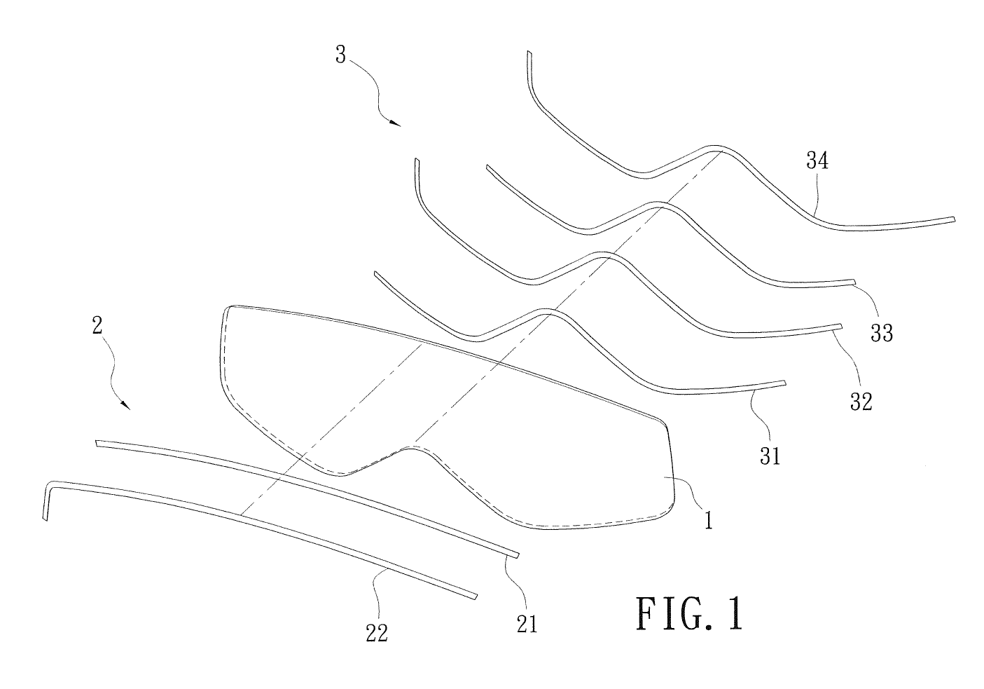

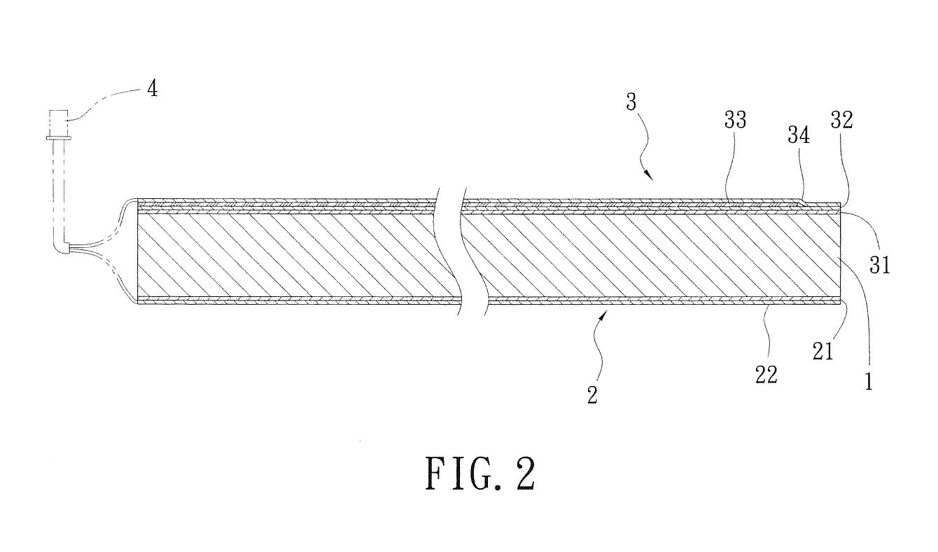

As referring to FIG. 1 and FIG. 2, they show a decomposed schematic diagram and a schematic cross-sectional top view showing the conductive assembly for changing the color of a lens according to the present invention. The present invention comprises a first conductive device 2 and a second conductive device 3 separately disposed at an upper front end face and a lower rear end face of an electrochromic lens 1. When the first conductive device 2 is a positive electrode, and the second conductive device 3 is a negative electrode. When the first conductive device 2 is a negative electrode, and the second conductive device 3 is a positive electrode, and an electrical connection device 4 is connected with the first conductive device 2 and the second conductive device 3.

Further, the first conductive device 2 is provided with a first indium tin oxide (ITO) conductive part 21 on a first surface of the electrochromic lens 1, and a conductive part 22 on the first ITO conductive part 21 for connection to the electrical connection device 4.

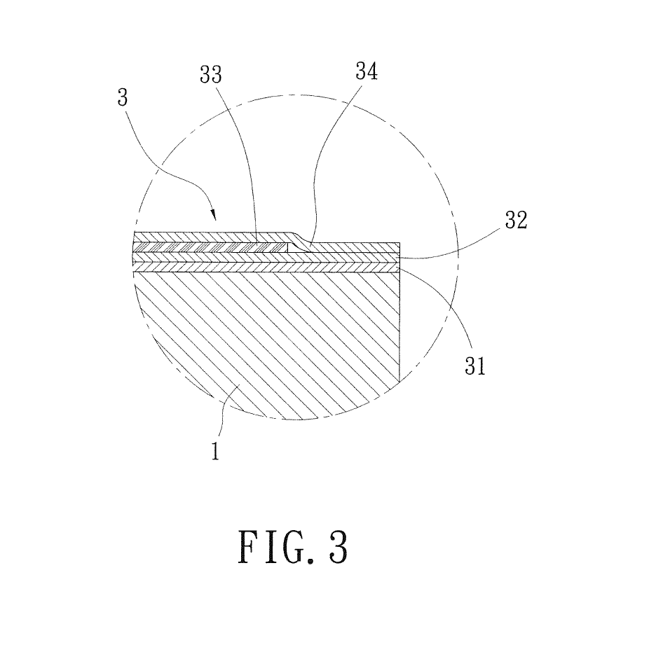

The second conductive device 3 is provided with a second indium tin oxide (ITO) conductive part 31 on a second surface of the electrochromic lens 1, an inner conductive part 32 on the second ITO conductive part 31, and an insulating part 33 on the inner conductive part 32 and an outer conductive part 34 on the insulating part 33, wherein the insulating part 33 is shorter than the inner conductive part 32 and the outer conductive part 34, and the outer conductive part 34 is connected to the electrical connection device 4 at an end thereof and to the inner conductive part 32 at the other end thereof (As referring to FIG. 3, it shows a partial enlarged schematic cross-sectional top view showing the conductive assembly for changing the color of a lens according to the present invention.)

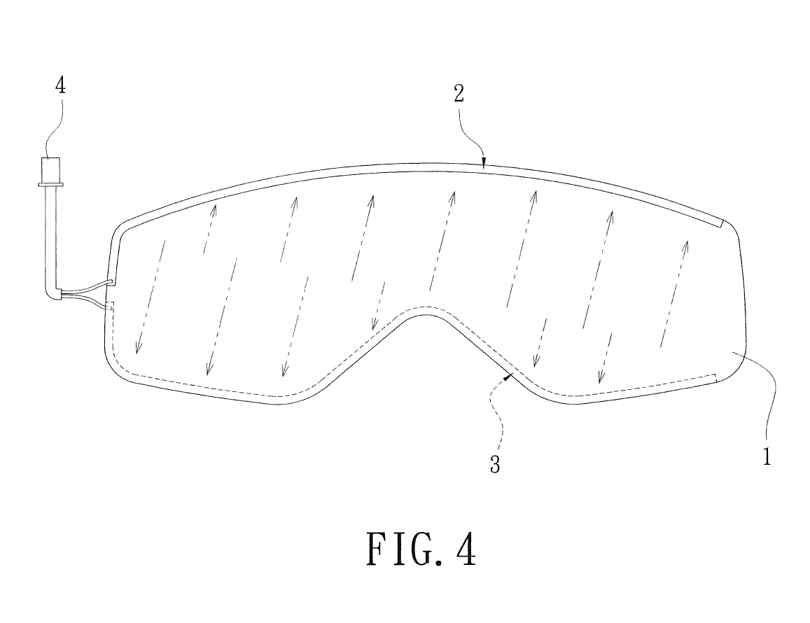

Thus, as referring to FIG. 4, it shows a diagram of the conductive assembly for changing the color of a lens in use according to the present invention. In the operation process, the first conductive device 2 and the second conductive device 3 are separately transmitted a forward power and a reverse power from the electrical connection device 4, and the forward and reverse powers are transmitted to the electrochromic lens 1 through the first ITO conductive part 21 and the conductive part 22 of the first conductive device 2, and the forward and reverse powers are inputted in one side of the outer conductive part 34 of the second conductive device 3. Because there is the insulating part 33 between the inner conductive part 32 and the outer conductive part 34, the forward and reverse powers are transmitted from the junction between the inner conductive part 32 and the outer conductive part 34 to the electrochromic lens 1 through the second ITO conductive part 31, so that the transmittance and color of the electrochromic lens 1 are changed. In the procedure of change of the transmittance and color of the electrochromic lens 1, because of the first ITO conductive part 21 of the first conductive device 2 and the second ITO conductive part 31 of the second conductive device 3 are not in the same side, the positions of the powers provided to the electrochromic lens 1 are different, so that the transmittance and color will be changed diagonally toward the center. Thus not only is the transmittance and color of the electrochromic lens 1 more uniform but also the service life of the electrochromic lens 1 can be extended.

Compared with techniques available now, the present invention has the following advantages:
1. In the procedure of change of the transmittance and color of the electrochromic lens, because of the first ITO conductive part of the first conductive device and the second ITO conductive part of the second conductive device are not in the same side, the positions of the powers provided to the electrochromic lens are different, so that the transmittance and color will be changed diagonally toward the center. Thus not only is the transmittance and color of the electrochromic lens more uniform but also the service life of the electrochromic lens can be extended.
2. When the electrical connection device connects to the first conductive device and the second conductive device, the electrical connection device cannot connect to both sides of the electrochromic lens and the first conductive device and the second conductive device. The electrical connection device connect to the first conductive device and the second conductive device at the same side of the electrochromic lens, so that the setup of the electrical connection device is more easy and convenient, and the setting cost is reduced at the same time.

1. A conductive assembly for changing a color of
a lens, comprising:
a first conductive device disposed at an upper front end face of an electrochromic lens;
a second conductive device disposed at a lower rear end face of the electrochromic lens; and
an electrical connection device connected with the first and second conductive devices;
wherein one of the first and second conductive devices is a positive electrode and the other one of the first and second conductive devices is a negative electrode, and said electrical connection device is connected with both the first conductive device and the second conductive device at one side of either the left or right side of the electrochromic lens; and wherein the first conductive device has a first indium tin oxide (ITO) conductive part on a first surface of the electrochromic lens and a conductive part on the first ITO conductive part for connection to the electrical connection device, and wherein the second conductive device has a second indium tin oxide (ITO) conductive part on a second surface of the electrochromic lens, an inner conductive part on the second ITO conductive part, an insulating part on the inner conductive part and an outer conductive part on the insulating part, wherein at a side of the electrochromic lens opposite to that of the electrical connection device the insulating part is shorter in lateral length than the inner and outer conductive parts, and the outer conductive part is connected to the electrical connection device at an end thereof and to the inner conductive part at the other end thereof corresponding to where the insulating part is shorter in length; and wherein the positions from where the power is transmitted into the first conductive device and inner conductive part are respectively at opposite sides of the left and right sides of the electrochromic lens.

2. (canceled)

3. (canceled)
